(19) United States
(12) Patent Application Publication
(10) Pub. No.: US 2009/0186207 A1
(43) Pub. Date: Jul. 23, 2009

(54) POLYCARBONATE RESIN COMPOSITION, MOLDED ARTICLE THEREOF, FILM, AND SHEET

(75) Inventors: Yusuke Hayata, Chiba (JP); Akio Nodera, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: IDEMITSU KOSAN CO., LTD., TOKYO (JP)

(21) Appl. No.: 12/097,889

(22) PCT Filed: Dec. 15, 2006
(86) PCT No.: PCT/JP2006/325095

§ 371 Date: Jun. 18, 2008

(30) Foreign Application Priority Data
Dec. 21, 2005 (JP) 2005-368416

(51) Int. Cl. B32B 27/00; C08L 83/04; C08L 69/00

(52) U.S. Cl. 428/220; 525/69; 524/537; 428/332

(57) ABSTRACT

The present invention provides a polycarbonate resin composition comprising 100 parts by mass of (A) a resin component comprising from 5 to 100% by mass of (A-1) an aromatic polycarbonate resin comprising dihydroxybiphenyl as a part of a divalent phenol as a raw material and from 95 to 0% by mass of (A-2) an aromatic polycarbonate resin other than the aromatic polycarbonate resin, and from 0.5 to 10 parts by mass of (B) a polyorganosiloxane-containing graft copolymer, the graft copolymer being dispersed to have an average dispersed particle diameter of from 0.1 to 1.0 μm, and a thin-walled molded article, a film and a sheet thereof, and the polycarbonate resin composition is excellent in balance among high flame retardancy, high rigidity, high impact resistance and flowability to be applicable to a thin-walled molded article, a film and a sheet.

### TECHNICAL FIELD

The present invention relates to a polycarbonate resin composition, and a molded article, a film and a sheet thereof. More specifically, it relates to a polycarbonate resin composition that has excellent flame retardancy, is excellent in balance among high rigidity, impact resistance and flowability, and suitable for a thin-walled molded article, a film and a sheet of an electric or electronic member, an optical member, a building member, an office automation equipment, an electric or electronic equipment, an information or communication equipment and the like, and a molded article, a film and a sheet thereof.

### BACKGROUND ART

A polycarbonate resin is widely used as a material and the like of an office automation equipment, an electric or electronic member, a household appliance, a building member, an automobile member and the like, owing to the excellent impact resistance, heat resistance, electric characteristics and the like thereof. A polycarbonate resin has high flame retardancy as compared to a polystyrene resin and the like, but the flame retardancy is tried to be further improved by adding various flame retardants since there are fields where higher flame retardancy is demanded including mainly such fields as an office automation equipment and an electric or electronic member.

For example, an organic halogen compound and an organic phosphorus compound have been conventionally added. However, most of the flame retardants have a problem in toxicity, and in particular, an organic halogen compound has such a problem in that it generates a corrosive gas upon combustion. Accordingly, flame retardation with a non-halogen and non-phosphorus flame retardant is increasingly demanded in recent years.

As a non-halogen and non-phosphorus flame retardant, the use of a polyorganosiloxane compound has been variously proposed.

For example, it has been known that a polyorganosiloxane-containing graft copolymer formed by graft-polymerizing a vinyl monomer to polyorganosiloxane particles of 0.2 μm or less is mixed with a thermoplastic resin to provide a flame retardant resin composition (for example, Patent Document 1). The flame retardant resin composition satisfies impact resistance to a certain extent but is insufficient in flame retardancy to have a problem of poor balance between flame retardancy and impact resistance.

As a measure for solving the problems, a polyorganosiloxane-containing graft copolymer flame retardant obtained by polymerizing (B) a polyfunctional monomer and another copolymerizable monomer in the presence of (A) polyorganosiloxane particles and further polymerizing (C) a vinyl monomer has been disclosed, and it has been known that the flame retardant is mixed with a thermoplastic resin to provide a flame retardant resin composition excellent in flame retardancy and impact resistance (for example, Patent Document 2).

(A) The polyorganosiloxane particles in the graft copolymer has an average particle diameter of from 0.008 to 0.6 μm, and upon mixing them with a polycarbonate resin, aggregated bodies having a dispersed particle diameter of about 3 μm are formed due to the low dispersibility thereof. Consequently, the resulting polycarbonate resin composition has such a problem in that it is insufficient in flame retardancy when the composition is used as a thin-walled molded article, a film and a sheet.

For example, in the case where the mixing amount of the graft copolymer is changed for solving the problem, there is less effect on flame retardancy. Accordingly, a polycarbonate resin composition having excellent flame retardancy when it is applied to a thin-walled molded article, a film and a sheet is difficult to provide by the approach of the graft copolymer.

### Patent Document 1: JP-A-2000-264935

### Patent Document 2: JP-A-2003-238639

### DISCLOSURE OF THE INVENTION

The present invention is to solve the problems, and an object thereof is to provide such a polycarbonate resin composition that is excellent in balance among high flame retardancy, high rigidity, high impact resistance and flowability to be applicable to a thin-walled molded article of 1 mm or less, a film and a sheet, by improving a polycarbonate resin in flame retardancy to bring out synergistic effect of the polycarbonate resin and a polyorganosiloxane-containing graft copolymer as a flame retardant.

As a result of earnest investigations made by the inventors for attaining the object, it has been found that the problem can be solved by mixing a polyorganosiloxane-containing graft copolymer as a flame retardant component with an aromatic polycarbonate resin containing wholly or partially a polycarbonate-dihydroxybiphenyl copolymer, and thus the present invention has been completed.

Accordingly, the present invention provides:

1. a polycarbonate resin composition containing 100 parts by mass of (A) a resin component containing from 5 to 100% by mass of (A-1) an aromatic polycarbonate resin containing dihydroxybiphenyl as a part of a divalent phenol as a raw material and from 95 to 0% by mass of (A-2) an aromatic polycarbonate resin other than the aromatic polycarbonate resin, and from 0.5 to 10 parts by mass of (B) a polyorganosiloxane-containing graft copolymer, the graft copolymer being dispersed to have an average dispersed particle diameter of from 0.1 to 1.0 μm,

2. the polycarbonate resin composition according to the item 1, wherein the aromatic polycarbonate resin as the component (A-1) or the component (A-2) has a viscosity average molecular weight of from 10,000 to 50,000,

3. the polycarbonate resin composition according to the item 1 or 2, wherein the composition further contains from 0.1 to 5 parts by mass of (C) a bisphenol type epoxy compound per 100 parts by mass of the aromatic polycarbonate resin as the component (A),

4. the polycarbonate resin composition according to one of the items 1 to 3, wherein the composition further contains from 0.05 to 2 parts by mass of (D) polytetrafluoroethylene having fibril-forming capability per 100 parts by mass of the aromatic polycarbonate resin as the component (A),

5. the polycarbonate resin composition according to one of the items 1 to 4, wherein the composition further contains from 5 to 100 parts by mass of (E) a fibrous inorganic filler per 100 parts by mass of the aromatic polycarbonate resin as the component (A),

6. a molded article having a part having a thickness of 1 mm or less containing the polycarbonate resin composition according to one of the items 1 to 5 having been molded, and

7. a film or a sheet having a thickness of 1 mm or less containing the polycarbonate resin composition according to one of the items 1 to 5 having been molded.

According to the present invention, a polycarbonate resin composition excellent in balance among high flame retardancy with a thin-walled molded article, high rigidity, high impact resistance and flowability, and a thin-walled molded article, a film and a sheet thereof can be obtained.

### BEST MODE FOR CARRYING OUT THE INVENTION

### (A) Aromatic Polycarbonate Resin

The polycarbonate resin composition of the present invention is a composition containing (A) an aromatic polycarbonate resin (which may be hereinafter referred simply to as a component (A) in some cases).

The component (A) contains (A-1) an aromatic polycarbonate resin containing dihydroxybiphenyl as a part of a divalent phenol as a raw material (which may be hereinafter referred simply to as a component (A-1)) and (A-2) an aromatic polycarbonate resin other than the aromatic polycarbonate resin as the component (A-1) (which may be hereinafter referred simply to as a component (A-2)).

In the present invention, the component (A-1) can be obtained by replacing a part of a divalent phenol by dihydroxybiphenyl upon polymerization of the aromatic polycarbonate resin as the component (A-2). Examples of the aromatic polycarbonate resin as the component (A-2) include various kinds thereof without particular limitation. In general, an aromatic polycarbonate produced through reaction of a divalent phenol and a carbonate precursor can be used. For example, an aromatic polycarbonate produced by a solution method or a fusion method, i.e., through reaction of a divalent phenol and phosgene or an ester exchange method of a divalent phenol and diphenyl carbonate or the like can be used.

Examples of the divalent phenol include various compounds and particularly include compounds of a bis(hydroxyphenyl)alkane series, such as 2,2-bis(4-hydroxyphenyl)propane[bisphenol A], bis(4-hydroxyphenyl)methane, 1,1-bis(4-hydroxyphenyl)ethane and 2,2-bis(3,5-dimethyl-4-hydroxyphenyl)propane, a bis(4-hydroxyphenyl)cycloalkane series, such as 1,1-bis(4-hydroxyphenyl)-3,3,5-trimethylcyclohexane, a bis(4-hydroxyphenyl)sulfide series, such as bis(3,5-dimethyl-4-hydroxyphenyl)sulfide, a bis(hydroxyphenyl)sulfone series, such as bis(3-chloro-4-hydroxyphenyl)sulfone, a bis(hydroxyphenyl)sulfoxide series, such as bis(4-hydroxyphenyl)sulfoxide, a bis(hydroxyphenyl)ether series, such as bis(3,5-dimethyl-4-hydroxyphenyl)ether, and a bis(hydroxyphenyl)ketone series, such as 3,3′,5,5′-tetramethyl-4,4′-dihydroxybenzophenone.

Preferred examples of the divalent phenol include a bis(hydroxyphenyl) alkane series, and particularly preferred examples thereof include one formed from bisphenol A as a main material.

Examples of the polycarbonate precursor include carbonyl halide, haloformate, diaryl carbonate and dialkyl carbonate, and specific examples thereof include phosgene, dihaloformate of a divalent phenol, diphenyl carbonate, dimethyl carbonate and diethyl carbonate. Examples of the divalent phenol include hydroquinone, resorcin and catechol. The divalent phenols may be used solely or as a mixture of two or more of them.

In the present invention, the aromatic polycarbonate resins as the components (A-1) and (A-2) may contain from 1 to 80% by mass of a branched polycarbonate (branched PC) depending on necessity. In this range, high flame retardancy can be obtained. The mixing amount of the branched polycarbonate is preferably from 5 to 50% by mass.

Examples of the branching agent for obtaining the branched polycarbonate include 1,1,1-tris(4-hydroxyphenyl)ethane, α,α′,α″-tris(4-hydroxyphenyl)-1,3,5-triisopropylbenzene, fluoroglycine, trimellitic acid and isatin bis(o-cresol).

In the present invention, as the aromatic polycarbonate resins used as the components (A-1) and (A-2), a copolymer, such as a polyester-polycarbonate resin obtained by polymerizing polycarbonate in the presence of an ester precursor, such as a bifunctional carboxylic acid, e.g., terephthalic acid, or an ester-forming derivative thereof, or a mixture of various kinds of polycarbonate resins may be used.

In the present invention, the viscosity average molecular weights of the aromatic polycarbonate resins used as the components (A-1) and (A-2) are each generally from 10,000 to 50,000. In this range, excellent balance between mechanical property and flowability can be obtained. It is preferably from 13,000 to 35,000, and more preferably from 14,000 to 22,000. The viscosity average molecular weight (Mv) is obtained in such a manner that a viscosity of a methylene chloride solution is measured at 20° C. with an Ubbelohde viscometer to obtain a limiting viscosity [η], and Mv is calculated by the following expression.

[η]=1.23×10⁻⁵ Mv^{0.83}

In the present invention, as the aromatic polycarbonate resins as the components (A-1) and (A-2), a polyorganosiloxane-containing aromatic polycarbonate resin may be used. The polyorganosiloxane-containing aromatic polycarbonate resin contains a polycarbonate part and a polyorganosiloxane part, and can be produced, for example, in such a manner that a polycarbonate oligomer and a polyorganosiloxane having a reactive group at an end thereof constituting the polyorganosiloxane part are dissolved in a solvent, such as methylene chloride, to which a sodium hydroxide aqueous solution of bisphenol A is added, and interface polycondensation reaction is carried out by using a catalyst, such as triethylamine.

The polyorganosiloxane-containing aromatic polycarbonate resin is disclosed, for example, in JP-A-3-292359, JP-A-4-202465, JP-A-8-81620, JP-A-8-302178 and JP-A-10-7897.

In the polyorganosiloxane-containing aromatic polycarbonate resin, the polymerization degree of the polycarbonate part is preferably about from 3 to 100, and the polymerization degree of the polyorganosiloxane part is preferably about from 2 to 500. The content of polyorganosiloxane in the polyorganosiloxane-containing aromatic polycarbonate resin is generally from 0.1 to 2% by mass, and preferably from 0.3 to 1.5% by mass.

The polyorganosiloxane-containing aromatic polycarbonate resin generally has a viscosity average molecular weight of from 10,000 to 50,000, preferably from 13,000 to 35,000, and particularly preferably from 14,000 to 22,000.

The polyorganosiloxane-containing aromatic polycarbonate resin is useful in view of improvement in impact resistance. The polyorganosiloxane in the polyorganosiloxane-containing aromatic polycarbonate resin is preferably polydimethylsiloxane, polydiethylsiloxane and polymethyphenylsiloxane, and particularly preferably polydimethylsiloxane.

The viscosity average molecular weight (Mv) herein can be obtained in the similar manner as the polycarbonate resin.

In the present invention, as the aromatic polycarbonate resins as the components (A-1) and (A-2), an aromatic polycarbonate resin having an alkyl group having from 1 to 35 carbon atoms, and preferably from 4 to 24 carbon atoms, as a molecular end group may be used depending on necessity.

The aromatic polycarbonate resin having an alkyl group having from 1 to 35 carbon atoms as a molecular end group can be obtained by using an alkylphenol having an alkyl group having from 1 to 35 carbon atoms as a terminating agent upon production of the polycarbonate resin.

Examples of the alkylphenol include cresol, tert-butylphenol, tert-octylphenol, nonylphenol, tert-amylphenol, decylphenol, undecylphenol, dodecylphenol, tridecylphenol, tetradecylphenol, pentadecylphenol, hexadecylphenol, heptadecylphenol, octadecylphenol, nonadecylphenol, eicosylphenol, docosylphenol, tetracosylphenol, hexacosylphenol, octacosylphenol, triacontylphenol, dotriacontylphenol and pentatriacontylphenol.

The alkyl group of the alkylphenol may be present at any of the o-, m- and p-positions with respect to the hydroxyl group, and preferably at the p-position. The alkyl group may be linear, branched or a mixture thereof.

As the substituents on the aromatic polycarbonate resin, at least one thereof may be the alkyl group having from 1 to 35 carbon atoms, and the other four are not particularly limited and may be an alkyl group having from 1 to 9 carbon atoms, an aryl group having from 6 to 20 carbon atoms, a halogen atom or unsubstituted.

The aromatic polycarbonate resin having an alkyl group having from 1 to 35 carbon atoms as a molecular end group, for any of the aromatic polycarbonate resins as the components (A-1) and (A-2), can be obtained, for example, by using the alkyl phenol as a terminating for controlling the molecular weight in the reaction of a divalent phenol and phosgene or a carbonate ester compound.

More specifically, the aromatic polycarbonate resin having an alkyl group having from 1 to 35 carbon atoms as a molecular end group can be obtained through reaction of a divalent phenol and phosgene or a polycarbonate oligomer in a methylene chloride solvent in the presence of a catalyst, such as triethylamine, and the phenol having an alkyl group having from 1 to 35 carbon atoms.

The phenol having an alkyl group having from 1 to 35 carbon atoms terminates one end or both ends of the polycarbonate resin to modify the ends. The modification of ends is 20% or more, and preferably 50% or more, based on the total ends. Accordingly, the other ends are hydroxyl ends or ends terminated with other terminating agents described below.

Examples of the other terminating agent include phenol, p-cumylphenol, bromophenol, tribromophenol and pentabromophenol, which are ordinarily used upon production of a polycarbonate resin. Among these, compounds containing no halogen are preferred in view of environmental issues.

As having been described, the aromatic polycarbonate resin (A-1) using dihydroxybiphenyl as a part of a divalent phenol as a raw material can be obtained by replacing a part of a divalent phenol by dihydroxybiphenyl upon polymerization of the aromatic polycarbonate resin as the component (A-2). Examples of the dihydroxybiphenyl include a compound represented by the following general formula (I):

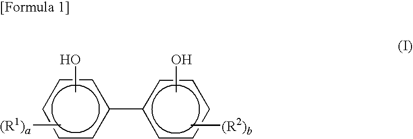

(In the formula, R¹ and R² each independently represent a group selected from a hydrogen atom, an alkyl group having from 1 to 6 carbon atoms, a cycloalkyl group having from 5 to 7 carbon atoms, a substituted or unsubstituted aryl group having from 6 to 12 carbon atoms and a halogen atom. a and b each independently represent an integer of from 1 to 4.) Specific examples thereof include 4,4′-dihydroxybiphenyl, 3,3′-dimethyl-4,4′-dihydroxybiphenyl, 3,5,3′,5′-tetramethyl-4,4′-dihydroxybiphenyl, 3,3′-diphenyl-4,4′-dihydroxybiphenyl and 2,3,5,6,2′,3′,5′,6′-hexafluoro-4,4′-dihydroxybiphenyl. Preferred examples thereof include 4,4′-dihydroxybiphenyl.

The dihydroxybiphenyl is used in combination with a divalent phenyl upon polymerization of the aromatic polycarbonate, and the using amount thereof is generally from 5 to 50% by mol, and preferably from 5 to 30% by mol, based on the total amount of the divalent phenol. In the case where the content of the dihydroxybiphenyl is fro 5 to 50% by mol, sufficient flame retarding effect can be obtained, and good impact resistance can also be obtained.

In the present invention, the component (A) is a resin component containing from 5 to 100% by mass of the aromatic polycarbonate resin as the component (A-1) and from 95 to 0% by mass of the aromatic polycarbonate resin as the component (A-2), and in the case where the component (A-1) is from 5 to 100% by mass, sufficient flame retardancy can be obtained in a thin-walled form. As the preferred ranges, the component (A-1) is from 10 to 100% by mass, and the component (A-2) is from 90 to 0% by mass.

### (B) Polyorganosiloxane-containing Graft Copolymer

The polycarbonate resin composition of the present invention is a composition containing (B) a polyorganosiloxane-containing graft copolymer (which may be hereinafter referred simply to as a component (B) in some cases).

The component (B) is a component added as a flame retardant for imparting flame retardancy to the polycarbonate resin. The component (B) is not particularly limited, and preferred specific examples of the component (B) include a polyorganosiloxane-containing graft copolymer obtained in such a manner that from 0.5 to 10 parts by mass of (G) a vinyl monomer containing from 100 to 50% by mass of (g-1) a polyfunctional monomer and from 0 to 50% by mass of (g-2) another copolymerizable monomer is polymerized in the presence of from 40 to 90 parts by mass of (F) polyorganosiloxane particles, and from 5 to 50 parts by mass (based on 100 parts by mass in total of (F), (G) and (H)) of a vinyl monomer is further polymerized.

More preferred examples of the component (B) include one obtained in such manner that from 1 to 5 parts by mass of the vinyl monomer (G) is polymerized in the presence of from 60 to 80 parts by mass of the polyorganosiloxane particles (F), and from 15 to 39 parts by mass of the vinyl monomer (H) is further polymerized to make 100 parts by mass in total.

The polyfunctional monomer (g-1) is a compound containing two or more polymerizable unsaturated bonds in the molecule, and specific examples thereof include allyl methacrylate, triallyl cyanurate, triallyl isocyanurate, diallyl phthalate, ethylene glycol dimethacrylate, 1,3-butyrene glycol dimethacrylate and divinylbenzene. These may be used solely or in combination of two or more of them. Among these, allyl methacrylate is preferably used in view of economy and advantage.

Specific examples of the copolymerizable monomer (g-2) include an aromatic vinyl monomer, such as styrene, α-methylstyrene, p-methylstyrene and p-butylstyrene, a vinyl cyanide monomer, such as acrylonitrile and methacrylonitrile, a (meth)acrylate ester monomer, such as methyl acrylate, ethyl acrylate, propyl acrylate, butyl acrylate, 2-ethylhexyl acrylate, glycidyl acrylate, hydroxyethyl acrylate, hydroxybutyl acrylate, methyl methacrylate, ethyl methacrylate, butyl methacrylate, lauryl methacrylate, glycidyl methacrylate and hydroxyethyl methacrylate, and a carboxyl group-containing vinyl monomer, such as itaconic acid, (meth) acrylic acid, fumaric acid and maleic acid. These may be used solely or in combination of two or more of them.

The vinyl monomer (H) is a component for obtaining the polyorganosiloxane-containing graft copolymer, and is also a component for ensuring the compatibility of the graft copolymer with the aromatic polycarbonate resin to disperse the graft copolymer uniformly in the aromatic polycarbonate resin upon adding the graft copolymer to the aromatic polycarbonate resin for improving the flame retardancy and the impact resistance thereof. Accordingly, the vinyl monomer (H) is preferably selected to attain the solubility parameter of a polymer of the vinyl monomer of from 9.15 to 10.15 ((cal/cm³)^{1/2}), more preferably from 9.17 to 10.10 ((cal/cm³)^{1/2}) and particularly preferably from 9.20 to 10.05 ((cal/cm³)^{1/2}). In the case where the solubility parameter is in the range, there is a tendency of improving the flame retardancy.

The solubility parameter is disclosed in detail in JP-A-2003-238639.

The component (B) preferably has an average particle diameter of from 0.1 to 1.0 μm in terms of a value obtained by observation with an electron microscope. In the case where the average particle diameter of the component (B) is in the range, sufficient flame retardancy, rigidity and impact resistance can be obtained.

The component (B) may be used solely or as a combination of two or more kinds thereof.

The mixing amount of the component (B) is generally from 0.5 to 10 parts by mass per 100 parts by mass of the component (A). In the case where the mixing amount of the component (B) is in the range, sufficient flame retardancy is obtained, and the impact resistance and the rigidity are improved. The mixing amount of the component (B) is preferably from 1 to 5 parts by mass.

(C) Bisphenol type Epoxy Compound

The polycarbonate resin composition of the present invention may contain (C) a bisphenol type epoxy compound (which may be hereinafter referred simply to as a component (C) in some cases) depending on necessity for improving the dispersibility of the component (B). It is important that the component (C) is bisphenol type. An epoxy compound, for example, of a novolak type is insufficient for dispersion of the component (B).

The component (C) is not particularly limited as far as it is a bisphenol type epoxy compound, and commercially available products may be appropriately used. Examples thereof include a bisphenol A type epoxy compound, a bisphenol F type epoxy compound, a bisphenol S type epoxy compound, a bisphenol AD type epoxy compound and halogenated phenol type epoxy compounds thereof. Among these, a bisphenol A type epoxy compound is particularly preferred. The epoxy compound preferably has an epoxy equivalent of from 180 to 3,500, and particularly preferably from 500 to 2,000.

The epoxy compound can be represented by the following general formula (II):

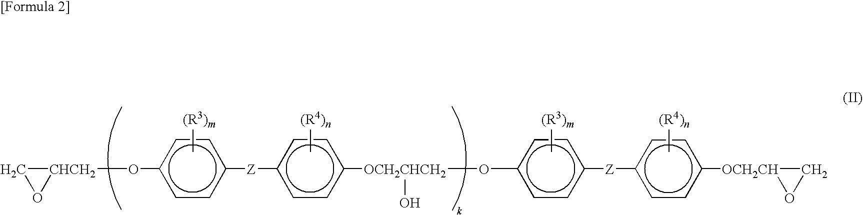

(In the formula, Z represents an alkylene group having from 1 to 8 carbon atoms, an alkylidene group having from 2 to 8 carbon atoms, a cycloalkylene group having from 5 to 15 carbon atoms, a cycloalkylydene group having from 5 to 15 carbon atoms, a single bond, an —SO₂—, —SO—, —S—, —O— or —CO— bond, or groups represented by the following formula:

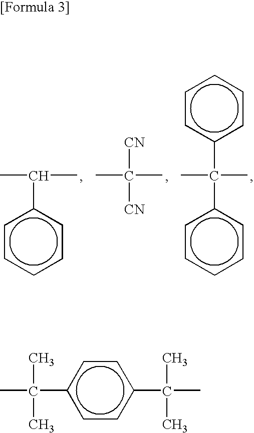

and hydrogen atoms of Z may be partially or wholly substituted by a halogen atom. R³ and R⁴ each represent a hydrogen atom, a halogen atom or an alkyl group having from 1 to 8 carbon atoms, and may be the same as or different from each other. m and n each represent an integer of from 1 to 4, and in the case where m and n each indicate plurality, R³ and R⁴ may be different from each other. k represents 0 or an integer of 1 or more.)

The component (C) may be used solely or as a combination of two or more kinds thereof.

The mixing amount of the component (C) is generally from 0.1 to 5 parts by mass per 100 parts by mass of the component (A). In the case where the mixing amount of the component (C) is in the range, the dispersibility and the melt tension of the component (B) can be further improved. The mixing amount of the component (C) is preferably from 0.1 to 2 parts by mass.

(D) Polytetrafluoroethylene having Fibril-forming Capability

The polycarbonate resin composition of the present invention may contain (D) polytetrafluoroethylene having fibril-forming capability (which may be hereinafter referred simply to as a component (D) in some cases) depending on necessity for improving the flame retardancy. The component (D) is not particularly limited as far as it has fibril-forming capability. The “fibril-forming capability” referred herein means a tendency of becoming a fibril form by binding the resin due to an external action, such as a shearing force.

The polytetrafluoroethylene having fibril-forming capability imparts an effect of preventing melt-dripping to the polycarbonate resin composition of the present invention to attain excellent flame retardancy.

Specific examples of the component (D) include polytetrafluoroethylene and a tetrafluoroethylene copolymer (such as a tetrafluoroethylene-hexafluoropropylene copolymer). Among these, polytetrafluoroethylene (which may be hereinafter referred to as “PTFE” is some cases) is preferred.

The PTFE having fibril-forming capability has an extremely high molecular weight, which is generally 500,000 or more, preferably from 500,000 to 15,000,000, and more preferably from 1,000,000 to 10,000,000, in terms of a number average molecular weight obtained from a standard specific gravity. The PTFE can be obtained, for example, by polymerizing tetrafluoroethylene in an aqueous solvent in the presence of sodium, potassium or ammonium peroxydisulfide under a pressure of from 6.9 to 690 kPa (from 1 to 100 psi) at a temperature of from 0 to 200° C., and preferably from 20 to 100° C. As the PTFE, one in the form of aqueous dispersion can be used in addition to one in the form of solid.

As the PTFE having fibril-forming capability, for example, one classified into the type 3 according to the ASTM Standard may be used. Examples of commercially available products that are classified into the type 3 include Teflon 6-J (a trade name, produced by Du Pont-Mitsui Fluorochemicals Co., Ltd.), Polyflon D-1 and Polyflon F-103 (a trade name, produced by Daikin Industries, Ltd.) and CD-076 (a trade name, produced by Asahi Glass Co., Ltd.). In addition to the aforementioned type 3 products, further examples thereof include Argoflon F5 (a trade name, produced by La Montefluos SPA) and Polyflon MPA and Polyflon FA-100 (trade names, produced by Daikin Industries, Ltd.)

The component (D) may be used solely or as a combination of two or more kinds thereof.

The mixing amount of the component (D) is generally from 0.05 to 2 parts by mass per 100 parts by mass of the component (A). In the case where the mixing amount of the component (D) is in the range, the flame retardancy can be further improved. The mixing amount of the component (D) is preferably from 0.1 to 1.5 parts by mass.

### (E) Fibrous Inorganic Filler

The polycarbonate resin composition of the present invention may contain (E) a fibrous inorganic filler (which may be hereinafter referred simply to as a component (E) in some cases) depending on necessity for improving the rigidity and the flame retardancy. The component (E) is not particularly limited, and at least one selected from glass fibers, glass flakes and carbon fibers is preferred.

The glass fibers are preferably ones produced by using alkali-containing glass, low-alkali glass or non-alkali glass, and the form thereof may be any of roving, milled fibers, chopped strands and the like. The fiber diameter of the glass fibers is preferably from 3 to 30 μm. In this range, the polycarbonate resin composition has high rigidity to provide an improved appearance of a molded article and the like. The fiber length of the glass fibers is generally from 1 to 20 mm, and preferably from 5 to 15 mm. The glass fibers may be filled in pellets of the resin composition to have a fiber length of generally from 0.01 to 2 mm, and preferably from 0.05 to 1 mm, since the glass fibers fed to a kneading machine are broken upon kneading with the resin component.

It is preferred that the glass fibers are treated with a surface treating agent and further subjected to a bundling treatment with a bundling agent for improving the adhesion to the resin component, and then the glass fibers are mixed with the aromatic polycarbonate resin as the component (A), followed by melt-kneading. Examples of the surface treating agent for the glass fibers include a silane coupling agent, such as an aminosilane series, an epoxysilane series, a vinylsilane series and an acrylsilane series, and a coupling agent, such as a titanate series, an aluminum series, a chromium series, a zirconium series and boron series. Among these, a silane coupling agent and a titanate coupling agent are particularly preferably used. The surface treating method may be an aqueous solution method, an organic solvent method, a spraying method or the like having been generally used. Examples of the bundling agent used for the bundling treatment after the surface treatment include bundling agent of a urethane series, an acrylic series, an acrylonitrile-styrene copolymer series and an epoxy series. The bundling treatment method of the glass fibers with the bundling agent may be a known method, such as dip coating, roller coating, blow coating, flow coating and spray coating.

The glass flakes may be produced with the same material and can be subjected to the same surface treatment as the glass fibers. The size of the glass flakes is not particularly limited, and the thickness thereof is preferably from 3 to 30 μm as similar to the diameter of the glass fibers. In the case where dimensional accuracy is demanded for the molded article and the like, the glass flakes are preferably used and are preferably used in combination with the glass fibers or the carbon fibers.

As the carbon fibers, those obtained by baking cellulose fibers, acrylic fibers, lignin, petroleum pitch or coal pitch as a raw material are preferably used. The carbon fibers include such types as a flame resistant type, a carbonaceous type and a graphitic type depending on a condition upon baking and any of the types may be used. The form of the carbon fibers may be any of roving, milled fibers and chopped strands. The fiber diameter of the carbon fibers is preferably from 5 to 15 μm. The fiber length thereof is generally from 0.01 to 20 mm. The fiber length is preferably from 0.01 to 10 mm in pellets of the kneaded composition with the resin component. The carbon fibers are preferably subjected to a surface treatment with an epoxy resin or a urethane resin since the affinity with the resin components is improved.

The mixing amount of the component (E) is generally from to 100 parts by mass per 100 parts by mass of the component (A). In the case where the mixing amount of the component (E) is in the range, the bending elastic modulus (rigidity) can be improved. The mixing amount of the component (E) is preferably from 10 to 40 parts by mass.

### Other Components

The polycarbonate resin composition of the present invention may contain an additional synthetic resin and an elastomer, and an inorganic filler, an additive and the like, in addition to the components (A) to (E), unless the advantages of the present invention are impaired.

Examples of the additional synthetic resin include polyethylene, polypropylene, polymethyl methacrylate and polycarbonate other than the component (A).

Examples of the elastomer include isobutyrene-isoprene rubber, styrene-butadiene rubber, ethylene-propylene rubber and an acrylic elastomer.

Examples of the inorganic filler include calcium sulfate, calcium carbonate, calcium silicate, titanium oxide, alumina, silica, asbestos, talc, clay, mica and quartz powder. These may be mixed for improving the mechanical characteristics and the durability of the resin composition and for extending the composition.

Examples of the additive include an antioxidant of a hindered phenol series, a phosphorus series, an amine series and the like, an ultraviolet ray absorbent of a benzotriazole series, a benzophenone series and the like, an external lubricant of an aliphatic carboxylate ester series, a paraffin series and the like, a releasing agent, an antistatic agent and a colorant.

Preferred examples of the hindered phenol antioxidant include BHT (2,6-di-tert-butyl-p-cresol), Irganox 1076 (a trade name, produced by Ciba-Geigy Co., Ltd.), Irganox 1010 (a trade name, produced by Ciba-Geigy Co., Ltd.), Ethyl 330 (a trade name, produced by Ethyl Corporation) and Sumilizer GM (a trade name, produced by Sumitomo Chemical Industries, Ltd.).

Examples of the phosphorus antioxidant include antioxidants of a phosphite ester series and a phosphate ester series.

### Polycarbonate Resin Composition

The polycarbonate resin composition of the present invention can be obtained by mixing and melt-kneading the components (A) and (B), the components (C), (D) and (E) depending on necessity, and furthermore the other components, by an ordinary method. The operation can be carried out, for example, by using a ribbon blender, a Henschel mixer, a Banbury mixer, a drum tumbler, a uniaxial screw extruder, a biaxial screw extruder, a co-kneader, a multi-axial screw extruder and the like. The suitable heating temperature on melt-kneading is generally from 250 to 300° C.

In the polycarbonate resin composition of the present invention, the component (B) as the flame retardant component is controlled to be dispersed uniformly as primary particles having an average dispersed particle diameter of from 0.1 to 1.0 μm in the resin composition. In this range, sufficient flame retardancy, rigidity and impact resistance can be obtained. The average dispersed particle diameter is preferably from 0.2 to 0.6 μm.

Molded Article, Film and Sheet using Polycarbonate Resin Composition

The polycarbonate resin composition of the present invention can be molded into a molded article, a film and a sheet that are excellent in flame retardancy and are thin-walled by applying to a known molding method, such as hollow molding, injection molding, extrusion molding, vacuum molding, pneumatic molding, heat bend molding, compression molding, calender molding and rotation molding.

In particular, the polycarbonate resin composition of the present invention is preferably used for producing a molded article having a part having a thickness of 1 mm or less or a film and a sheet having a thickness of 1 mm or less, which are demanded to have high flowability upon molding and flame retardancy upon using.

### Example

The present invention is described in more detail with reference to examples, but the present invention is not limited thereto.

### Production Example

### Production of Polycarbonate-dihydroxybiphenyl Copolymer

### (1) Synthesis Step of Polycarbonate Oligomer

0.2% by mass, based on bisphenol A (BPA) to be dissolved later, of sodium dithionite (Na₂S₂O₄) was added to a sodium hydroxide aqueous solution having a concentration of 5.6% by mass, in which BPA was dissolved to make a BPA concentration of 13.5% by mass, so as to prepare a sodium hydroxide aqueous solution of BPA. The sodium hydroxide aqueous solution of BPA in a flow rate of 40 L/hr and methylene chloride in a flow rate of 15 L/hr were continuously charged to a tubular reactor having an inner diameter of 6 mm and a tube length of 30 m, and phosgene in a flow rate of 4.0 kg/hr was continuously charged thereto. The tubular reactor had a jacket, and coolant water was charged to the jacket to maintain the temperature of the reaction liquid to 40° C. or less.

The reaction liquid discharged from the tubular reactor was continuously introduced to a tank reactor with a baffle having an inner capacity of 40 L, to which the sodium hydroxide aqueous solution of BPA in a flow rate of 2.8 L/hr, a 25% by mass sodium hydroxide aqueous solution in a flow rate of 0.07 L/hr, water in a flow rate of 17 L/hr and a 1% by mass triethylamine aqueous solution in a flow rate of 0.64 L/hr were continuously fed, so as to effect reaction at from 29 to 32° C. The reaction liquid was continuously discharged from the tank reactor and was allowed to stand to remove the aqueous phase, and the methylene chloride phase was collected. The polycarbonate oligomer solution thus obtained had an oligomer concentration of 338 g/L and a chloroformate group concentration of 0.71 mol/L.

### (2) Polymerizing Step of Polycarbonate-dihydroxybiphenyl Copolymer

15.0 L of the oligomer solution, 10.5 L of methylene chloride, 132.7 g of p-tert-butylphenol (PTBP) and 1.4 mL of triethylamine were charged in a tank reactor equipped with a baffle plate and paddle stirring blades having an inner capacity of 50 L, to which a sodium hydroxide aqueous solution of dihydroxybiphenyl (which was formed by dissolving 890 g of 4,4′-dihydroxybiphenyl in an aqueous solution formed by dissolving 640 g of sodium hydroxide and 1.8 g of sodium dithionite in 9.3 L of water) was added, followed by effecting polymerization reaction for 1 hour. After adding 10.0 L of methylene chloride for dilution, the mixture was allowed to stand to separate the mixture into an organic phase containing polycarbonate and an aqueous phase containing excessive 4,4′-dihydroxybiphenyl and sodium hydroxide, and the organic phase was isolated.

### (3) Rinsing Step

The methylene chloride solution of a polycarbonate-dihydroxybiphenyl copolymer obtained in the step (2) was rinsed sequentially with a 0.03 mol/L sodium hydroxide aqueous solution and 0.2 mol/L hydrochloric acid in an amount of 15% by volume based on the solution, and then repeatedly rinsed with pure water until the electroconductivity in the aqueous phase after rinsing became 0.05 μS/m or less.

### (4) Flaking Step

The methylene chloride solution of a polycarbonate-dihydroxybiphenyl copolymer obtained in the step (3) was condensed and pulverized to obtain flakes of the polycarbonate-biphenyl copolymer. The resulting flakes were dried under reduced pressure at 120° C. for 12 hours. The biphenyl content measured by a nuclear magnetic resonance (NMR) spectroscopy was 15.9% by mol.

### Examples 1 to 16 and Comparative Examples 1 to 9

The following materials were used as mixing components of polycarbonate resin compositions.

### Component (A-1)

PC-1: polycarbonate-dihydroxybiphenyl copolymer obtained in Production Example (viscosity average molecular weight: 17,500, biphenyl content: 15.9% by mol)

### Component (A-2)

PC-2: bisphenol A polycarbonate (A1500, a trade name, produced by Idemitsu Kosan Co., Ltd., viscosity average molecular weight: 14,500)

PC-3: branched PC (FB2500, a trade name, produced by Idemitsu Kosan Co., Ltd., viscosity average molecular weight: 25,000, with 1,1,1-tris(4-hydroxyphenyl)ethane used as branching agent)

### Component (B)

polyorganosiloxane-containing graft copolymer (MR-01, a trade name, produced by Kaneka Corporation, average particle diameter: 0.3 μm)

### Component (C)

bisphenol A type epoxy resin (Epiclon AM-040-P, a trade name, produced by Dainippon Ink And Chemicals, Inc., epoxy equivalent: 900)

### Component (D)

PTFE having fibril-forming capability (CD-076, a trade name, produced by Asahi Glass Co., Ltd.)

### Component (E)

E-1: GF; glass fibers (MA409C, a trade name, produced by Asahi Fiber Glass Co., Ltd., fiber diameter: 13 μm, fiber length 13 mm)

E-2: CF; carbon fibers (HTAC-6SRS, a trade name, produced by Toray Industries, Inc., fiber diameter: 6 μm, fiber length 13 mm)

The mixing components shown in Tables 1 and 2 each were dried and mixed in the ratios shown in Tables 1 and 2. The mixtures each were uniformly blended with a tumbler and then fed to a biaxial extrusion molding machine equipped with a vent of 35 mm in diameter (TEM35, produced by Toshiba Machine Co., Ltd.) to knead at a temperature of 280° C., and pellets thereof were formed.

The resulting pellets were dried at 120° C. for 10 hours and then injection-molded with an injection molding machine (TEM35, produced by Toshiba Machine Co., Ltd.) at a cylinder temperature of 280° C. and a mold temperature of 80° C. to obtain test pieces having a thickness of 1/32 inch (0.08 mm) and thin-walled injection-molded articles having a thickness of 1/64 inch (0.4 mm). The results obtained by subjecting the test pieces to the following measurements are shown in Tables 1 and 2.

### (1) and (2) Flame Retardancy

A vertical combustion test was carried out for the test pieces having a thickness of (1) 1/32 inch (0.8 mm) and (2) 1/64 inch (0.4 mm) prepared according to UL Standard 94. The test pieces were evaluated for any of V-0, V-1 and V-2 out (not-V) of UL 94 based on the test results.

### (3) Average Dispersed Particle Diameter of Polyorganosiloxane-containing Graft Copolymer (Component (B))

By using a test piece having a thickness of 1/64 inch (0.4 mm) formed by an injection molding machine, the aggregated part of the polyorganosiloxane-containing graft copolymer was photographed with a transmission electron microscope, and the diameters of dispersed particles were measured to obtain an average dispersed particle diameter.

(4) Izod Impact Strength with Notch (IZOD)

It was measured according to the ASTM Standard D-256 by using a test piece having a thickness of ⅛ inch (3.2 mm) formed by an injection molding machine.

### (5) Bending Elastic Modulus

A three-point bending test was carried out according to the ASTM Standard D-790 at a temperature of 23° C., a supporting point distance of 90 mm and a loading speed of 20 mm/min by using a test piece having a thickness of 4 mm and a length of 130 mm formed by an injection molding machine, and the bending elastic modulus was calculated from the gradient of the load-distortion curve obtained by the test.

### (6) Flowability

It was measured at a molding temperature of 280° C., a mold temperature of 80° C., a thickness of 1 mm, a width of 10 mm and an injection pressure of 7.85 MPa. The unit was cm.

TABLE 1

| | | | Examples | | | | | | | |
|---|---|---|---|---|---|---|---|---|---|---|
| Mixing components | | | 1 | 2 | 3 | 4 | 5 | 6 | 7 | 8 |
| Mixing | (A-1) | PC-1 | 100 | 100 | 100 | 100 | 100 | 100 | 100 | 100 |
| Ratio | (A-2) | PC-2 | — | — | — | — | — | — | — | — |
| (part | | PC-3 | — | — | — | — | — | — | — | — |
| by | (B) | Polyorganosiloxane-containing | 1 | 5 | 8 | 5 | 5 | 5 | 5 | 5 |
| mass) | | graft copolymer | | | | | | | | |
| | (C) | Bisphenol A type epoxy resin | — | — | — | 0.5 | 0.5 | 0.5 | — | — |
| | (D) | PTFE having fibril-forming | — | — | — | — | 0.5 | 0.5 | 0.5 | 0.5 |
| | | capability | | | | | | | | |
| | (E) | Glass fibers | — | — | — | — | — | 80 | — | 30 |
| | | Carbon fibers | — | — | — | — | — | — | — | — |
| Evaluation | (1) Flame retardancy | | V-0 | V-0 | V-0 | V-0 | V-0 | V-0 | V-0 | V-0 |
| | ( 1/32 inch (0.8 mm)) | | | | | | | | | |
| | (2) Flame retardancy | | V-1 | V-0 | V-0 | V-0 | V-0 | V-0 | V-0 | V-0 |
| | ( 1/64 inch (0.4 mm)) | | | | | | | | | |
| | (3) Average dispersed particle diameter | | 0.3 | 0.3 | 0.3 | 0.3 | 0.3 | 0.3 | 0.3 | 0.3 |
| | of Component (B) (μm) | | | | | | | | | |
| | (4) Izod impact strength (kJ/m²) | | 28 | 38 | 45 | 45 | 42 | 12 | 38 | 25 |
| | (5) Bending elastic modulus (23° C.) | | 2.3 | 2.2 | 2.1 | 2.2 | 2.2 | 12.9 | 2.2 | 8.2 |
| | (GPa) | | | | | | | | | |
| | (6) Flowability (280° C., 1 mm) (cm) | | 16 | 18 | 16 | 18 | 18 | 8 | 18 | 12 |
| | | | Examples | | | | | | | |
| Mixing components | | | 9 | 10 | 11 | 12 | 13 | 14 | 15 | 16 |
| Mixing | (A-1) | PC-1 | 100 | 80 | 70 | 70 | 70 | 70 | 55 | 50 |
| Ratio | (A-2) | PC-2 | — | — | 30 | 30 | 30 | — | 45 | 20 |
| (part | | PC-3 | — | 20 | — | — | — | 30 | — | 30 |
| by | (B) | Polyorganosiloxane-containing | 8 | 2 | 5 | 5 | 5 | 5 | 5 | 4 |
| mass) | | graft copolymer | | | | | | | | |
| | (C) | Bisphenol A type epoxy resin | 0.2 | 0.1 | — | 0.4 | 0.4 | 0.5 | — | 0.2 |
| | (D) | PTFE having fibril-forming | 0.3 | — | — | — | 0.5 | — | 0.5 | — |
| | | capability | | | | | | | | |
| | (E) | Glass fibers | — | — | — | — | — | — | — | — |
| | | Carbon fibers | — | — | — | — | 5 | 15 | — | — |

| | | | | | | | | | |
|---|---|---|---|---|---|---|---|---|---|
| Evaluation | (1) Flame retardancy | V-0 | V-0 | V-0 | V-0 | V-0 | V-0 | V-0 | V-0 |
| | ( 1/32 inch (0.8 mm)) | | | | | | | | |
| | (2) Flame retardancy | V-0 | V-0 | V-1 | V-1 | V-0 | V-0 | V-0 | V-0 |
| | ( 1/64 inch (0.4 mm)) | | | | | | | | |
| | (3) Average dispersed particle diameter | 0.3 | 0.5 | 0.3 | 0.3 | 0.3 | 0.3 | 0.3 | 0.4 |
| | of Component (B) (μm) | | | | | | | | |
| | (4) Izod impact strength (kJ/m²) | 60 | 42 | 50 | 50 | 26 | 18 | 46 | 54 |
| | (5) Bending elastic modulus (23° C.) | 2.1 | 2.2 | 2.2 | 2.2 | 5.5 | 6.4 | 2.2 | 2.2 |
| | (GPa) | | | | | | | | |
| | (6) Flowability (280° C., 1 mm) (cm) | 20 | 20 | 18 | 18 | 14 | 12 | 22 | 16 |

TABLE 2

| | | | Comparative Examples | | | | | | | | |
|---|---|---|---|---|---|---|---|---|---|---|---|
| Mixing components | | | 1 | 2 | 3 | 4 | 5 | 6 | 7 | 8 | 9 |
| Mixing | (A-1) | PC-1 | 100 | 70 | 100 | 100 | 70 | 100 | — | — | 2 |
| ratio | (A-2) | PC-2 | — | 30 | — | — | 30 | — | 100 | 80 | 98 |
| (part | | PC-3 | — | — | — | — | — | — | — | 20 | — |
| by | (B) | Polyorganosiloxane-containing | 0.3 | 0.3 | 0.1 | 13 | 13 | 12 | 5 | 2 | 5 |
| mass) | | graft copolymer | | | | | | | | | |
| | (C) | Bisphenol A type epoxy resin | — | — | 0.2 | — | — | 0.2 | — | 0.1 | — |
| | (D) | PTFE having fibril-forming | — | — | 0.5 | — | — | 0.3 | 0.5 | — | — |
| | | capability | | | | | | | | | |
| | (E) | Glass fibers | — | — | — | — | — | — | — | — | — |
| | | Carbon fibers | — | — | — | — | — | — | — | — | — |

| | | | | | | | | | | |
|---|---|---|---|---|---|---|---|---|---|---|
| Evaluation | (1) Flame retardancy ( 1/32 inch (0.8 mm)) | V-2 | V-2 | V-2 out | V-2 | V-2 | V-2 out | V-0 | V-0 | V-2 |
| | (2) Flame retardancy ( 1/64 inch (0.4 mm)) | V-2 | V-2 | V-2 out | V-2 | V-2 | V-2 out | V-1 | V-1 | V-2 |
| | (3) Average dispersed particle diameter of | 0.3 | 0.3 | 0.3 | 5 | 3 | 5 | 0.3 | 0.5 | 0.5 |
| | Component (B) (μm) | | | | | | | | | |
| | (4) Izod impact strength (kJ/m²) | 15 | 16 | 15 | 18 | 20 | 20 | 42 | 45 | 40 |
| | (5) Bending elastic modulus (23° C.) (GPa) | 2.3 | 2.3 | 2.3 | 2 | 2.1 | 2 | 2.2 | 2.2 | 2.2 |
| | (6) Flowability (280° C., 1 mm) (cm) | 8 | 8 | 18 | 20 | 20 | 20 | 20 | 20 | 18 |

The following were found from Tables 1 and 2.

### (1) Examples 1 to 16

The resulting molded articles attained flame retardancy of V-0 or V-1 even though the thickness thereof was as thin as 0.4 mm, and thus it was understood that they were excellent in impact strength, rigidity and flame retardancy with a thin-walled molded article.

### (2) Comparative Examples 1 to 3

Sufficient flame retardancy with a thin-walled molded article was not obtained with a small mixing amount of the component (B).

### (3) Comparative Examples 4 to 6

When the component (B) exceeded 10 parts by mass per 100 parts by mass of the component (A), the component (B) underwent aggregation to lower the flame retardancy with a thin-walled molded article.

### (4) Comparative Examples 7 to 9

The flame retardancy with a thin-walled molded article was lowered to some extent with a small amount of the component (A-1).

Accordingly, it was understood that in Examples 1 to 16, flame retardancy of V-0 or V-1 was attained even though the thickness of the resulting molded article was as thin as 0.4 mm since the average dispersed particle diameter of the component (B) in the resin composition was 1.0 μm or less, and furthermore, the molded articles were excellent in impact strength, rigidity and flowability.

### INDUSTRIAL APPLICABILITY

The polycarbonate resin composition of the present invention is excellent in balance among flame retardancy with a thin-walled molded article, rigidity, impact resistance and flowability, and can be preferably used as a thin-walled molded article, a film and a sheet in the fields where thin-walled light weight and higher flame retardancy are demanded including mainly such fields as an office automation equipment and an electric or electronic member.

1. A polycarbonate resin composition, comprising:
100 parts by mass of (A) a resin component comprising
from 5 to 100% by mass of (A-1) an aromatic polycarbonate resin comprising dihydroxybiphenyl as a part of a divalent phenol as a raw material and
from 95 to 0% by mass of (A-2) an aromatic polycarbonate resin other than the aromatic polycarbonate resin (A-1); and
from 0.5 to 10 parts by mass of (B) a polyorganosiloxane-containing graft copolymer, wherein the graft copolymer is dispersed to have an average dispersed particle diameter ranging from 0.1 to 1.0 μm.

2. The polycarbonate resin composition according to claim 1, wherein the aromatic polycarbonate resin as the component (A-1) or the component (A-2) has a viscosity average molecular weight ranging from 10,000 to 50,000.

3. The polycarbonate resin composition according to claim 1, wherein the composition further comprises from 0.1 to 5 parts by mass of (C) a bisphenol type epoxy compound per 100 parts by mass of the aromatic polycarbonate resin as the component (A).

4. The polycarbonate resin composition according to claim 1, wherein the composition further comprises from 0.05 to 2 parts by mass of (D) polytetrafluoroethylene having fibril-forming capability per 100 parts by mass of the aromatic polycarbonate resin as the component (A).

5. The polycarbonate resin composition according to claim 1, wherein the composition further comprises from 5 to 100 parts by mass of (E) a fibrous inorganic filler per 100 parts by mass of the aromatic polycarbonate resin as the component (A).

6. A molded article comprising the polycarbonate resin composition according to claim 1, wherein said molded article has a part having a thickness of 1 mm or less.

7. A film or a sheet comprising a polycarbonate resin composition according to claim 1 that has been molded, wherein said film or sheet has a thickness of 1 mm or less.
